(19) United States
(12) Patent Application Publication
(10) Pub. No.: US 2008/0170911 A1
(43) Pub. Date: Jul. 17, 2008

(54) Method And Apparatus For Laying Elongate Articles

(76) Inventors: Matthew Trevor Snowdon, Morpeth (GB); Michael William Shea, Aberdeenshire (GB)

Correspondence Address: C. JAMES BUSHMAN, 5718 WESTHEIMER, SUITE 1800, HOUSTON, TX, 77057, US

(21) Appl. No.: 10/594,777

(22) PCT Filed: Mar. 29, 2005
(86) PCT No.: PCT/GB05/01229

§ 371 Date: Oct. 4, 2007

(30) Foreign Application Priority Data
Mar. 30, 2004 (GB) 0407143.7
Dec. 24, 2004 (GB) 0428316.4

(51) Int. Cl. F16L 1/12

(52) U.S. Cl. 405/166

(57) ABSTRACT

This application describes apparatus (200, 6200, 8200) for laying elongate articles from a vessel (100) at sea. The apparatus comprising tensioning means (204, 6204, 8204) for controlling paying out of said articles along an axis of said tensioning means, and a structure tiltable (202, 6202, 8202) between upright and horizontal states. The apparatus is operable in a first mode, wherein the tensioning means is carried by said structure with its axis at an elevated angle and said structure for example also carries a radius controller (220, 6220, 8220) and a straightener (212, 6212, 8212), and in a second mode wherein the tensioning means is arranged with its axis substantially horizontal. The tiltable structure may be detachable from the tensioning means in the second mode, so as to assist in transferring in-line accessories overboard. Alternatively a separate A-frame may be provided for that purpose. This allows the same apparatus to be adapted for laying rigid and flexible pipes at different times, and/or in different depth ranges.

The present invention relates to methods and apparatuses for laying elongate articles at sea, and especially to pipe laying vessels.

Various methods and apparatus are known for laying continuous steel pipe (known as rigid pipe) from a vessel at the sea surface onto the seabed. The pipeline may be welded on board from sections, as disclosed in U.S. Pat. No. 5,975,802 (Willis/Stolt), or may be laid from a pre-loaded reel, as in U.S. Pat. No. 4,917,540 (Recalde/Santa Fe). For deep water, a steep angle of departure of the pipeline into the water must be arranged, using track tensioners, or other tensioning means such as movable clamps, in order to align with the natural catenary curve of the suspended pipeline. Bending of the pipe under this very high tension is liable to cause damage.

In addition to rigid pipes, flexible pipeline and cables may be laid from a vessel, typical from a coil in a carousel located below deck. Conventionally, the flexible pipe follows a horizontal path and is diverted over board via a sheave (wheel), to protect it against excessive bending. Vertical lay arrangements are known for flexible pipe, for example from EP 0717222 A (Stolt) and WO 91/15699 A (Coflexip Stena Offshore), but the horizontal path has advantages. In any case, generally vessels are specialised to one type of product (rigid or flexible), or are provided with separate apparatus for each type of product. This requires a larger vessel, and of course a greater cost of equipment. One vessel advertising capacity to handle both rigid and flexible product in a single apparatus is Technip/Coflexip ‘Deep Blue’, described in WO 00/66922 A1. However, this is a very large capacity and costly vessel, and therefore not necessarily adapted to all types of operation. Moreover the tensioners are fixed in vertical orientation which is not necessary or optimal for handling the flexible product in particular.

The invention aims to provide cost-effective methods and apparatus whereby a single vessel can be adapted readily between a configuration suitable to lay rigid pipe along a vertical path, and a configuration suitable for laying flexible pipe along a substantially horizontal path.

In a first aspect of the invention, there is provided an apparatus for laying elongate articles from a vessel at sea, the apparatus comprising tensioning means for controlling paying out of said articles along an axis of said tensioning means, a structure tiltable between upright and horizontal states, wherein the apparatus is operable in a first mode wherein the tensioning means is carried by said structure with its axis at an elevated angle, and in a second mode wherein the tensioning means is arranged with its axis substantially horizontal.

The tiltable structure in the first mode may carry a radius controller and a straightener for conditioning rigid pipe, at a position upstream of the tensioning means.

The radius controller and/or straightener may be provided at least partially in the form of modules to be removed when the structure is in the horizontal state. This alleviates space constraints and allows use of a smaller vessel.

The apparatus may further comprise overboarding means for receiving flexible elongate product from the horizontal tensioning means in the second mode. The overboarding means may comprise a sheave.

The overboarding means may be provided at least partially in the form of a module to be removed when the apparatus is in the first mode. Again, a compact apparatus is facilitated, and particularly avoiding congestion in the region where the pipe is launched from the vessel into the water.

The tiltable structure may be operable in the first mode to orient the tensioning means vertically and at a range of angles below vertical.

The tensioning means may be detached from the tiltable structure in the second mode, the tiltable structure being returned to an upright orientation for supporting loads independently of the tensioning means. The tiltable structure may in particular be operable in the second mode at a range of angles either side of vertical, to support in-line accessories as the product travels over said overboarding means.

The tensioner in the second mode may be located at a position displaced horizontally from a location from which it will be elevated by said tiltable structure in the first mode. Such an arrangement allows the centre of mass to be kept reasonably low when the tensioner is elevated in the first mode, while affording increased clearance between the tensioning means and the overboarding means in the second mode.

In a preferred embodiment, the tensioning means is detached from the tiltable structure in the second mode, and displaceable horizontally while detached from the tiltable structure.

The tiltable structure may for example take the form of a pair of legs pivoted to the deck of the vessel at their lower ends and joined by a crossbeam at their upper ends, the tensioning means in the first mode being carried between the legs below the crossbeam, with a straightener and radius controller mounted above the crossbeam and being detachable when adapting the apparatus into the second mode.

In alternative embodiments, the tiltable structure is movable bodily in order to provide said horizontal displacement of the tensioning means. This may be achieved as part of a single operation with lowering the structure about single pivot by placing the pivot point away from an axis of the tiltable structure.

The tiltable structure may alternatively be connected to the vessel by one or more arms pivotally connected at one end to the tiltable structure and at another end to the vessel. This can permit independent modes of movement for (i) lowering the structure from upright to horizontal and (ii) retracting the structure away from a launch point of the product, with various advantages. Alternative arrangements to support and reconfigure the structure are also possible.

In such alternative embodiments, the tensioning means may remain attached to the tiltable structure in both first and second modes.

The invention further provides methods of laying rigid articles and flexible elongate articles using such apparatus and methods of configuring such apparatus for different modes of use.

These and further features and advantages of the invention will be understood by the skilled reader from a consideration of the embodiments described below.

### BRIEF DESCRIPTION OF THE DRAWINGS

Embodiments of the invention will now be described, by way of example only, by reference to the accompanying drawings, in which:

FIG. 1 presents various general arrangement (GA) views of a pipe laying vessel incorporating novel pipe handling apparatus according to a first embodiment of the invention;

FIG. 2 is an enlarged partial side view of the vessel, showing the novel pipe handling apparatus in an upright mode;

FIG. 3 is an enlarged partial side view of the vessel, showing the novel pipe handling apparatus in a horizontal mode;

FIG. 4 is an enlarged partial plan view of the vessel corresponding to the side view of FIG. 3;

FIG. 5 is an enlarged partial plan view of the vessel corresponding to FIG. 4 but at a lower deck level;

FIGS. 6(a) and (b) are enlarged partial side views of an apparatus according to a second embodiment of the invention, in upright and horizontal mode respectively;

FIG. 7 illustrates steps (a) to (h) in the lowering and retraction of the apparatus of the second embodiment between vertical and horizontal modes;

FIGS. 8(a) and (b) are enlarged transverse section (looking sternward) and side views of an apparatus according to a third embodiment of the invention, in upright mode;

FIGS. 9(a) and (b) are enlarged transverse sectional views, and FIG. 9(c) is an enlarged partial side view of the apparatus of the third embodiment in horizontal mode;

FIG. 10 illustrates steps (a) to (f) in the conversion of the apparatus of the third embodiment between vertical and horizontal modes; and

FIG. 11 illustrates steps (a) to (c) in the operation of a movable linkage in an optional variation of step (e) in the third embodiment.

### DETAILED DESCRIPTION OF THE EMBODIMENTS

### General Arrangement (First Embodiment)

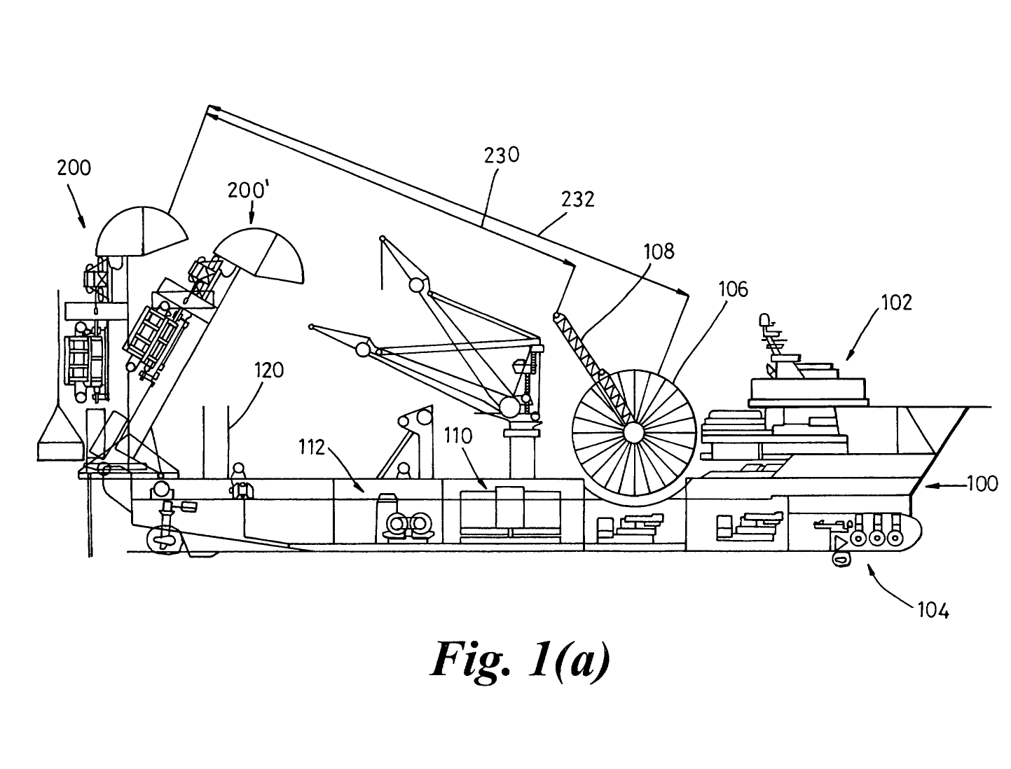

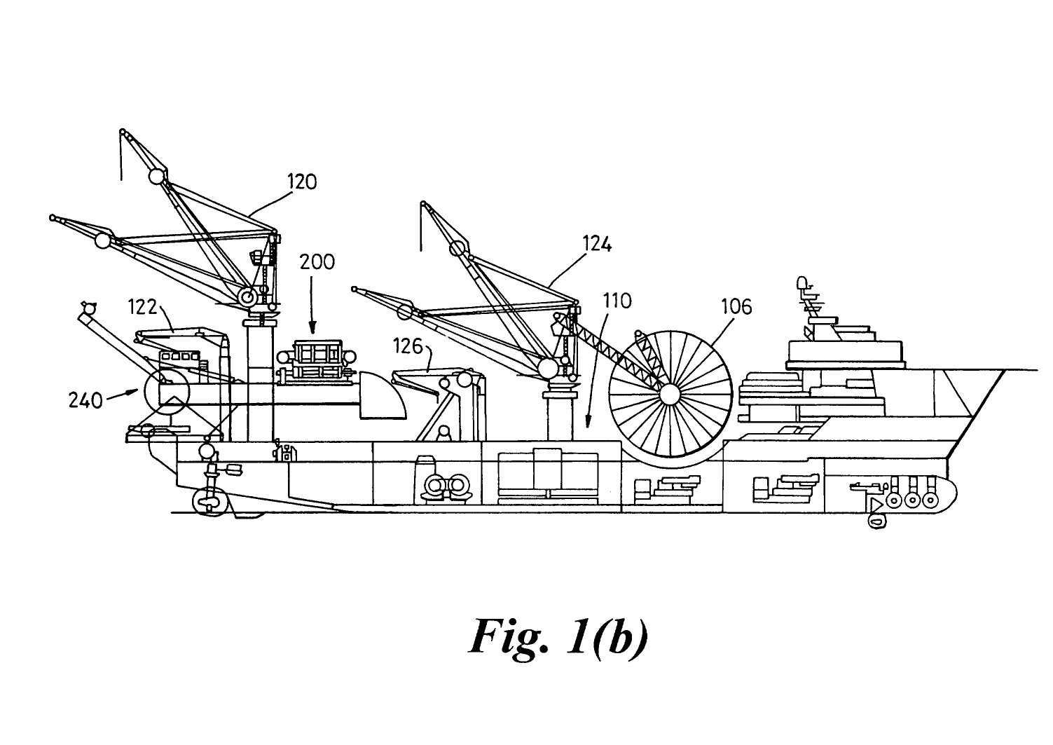

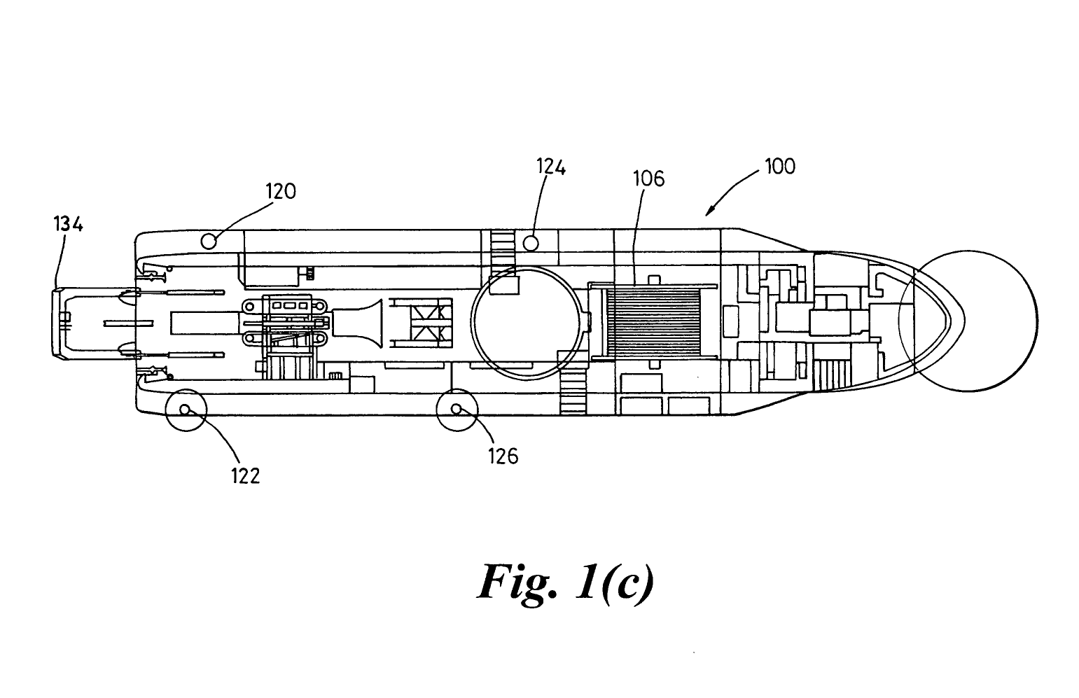

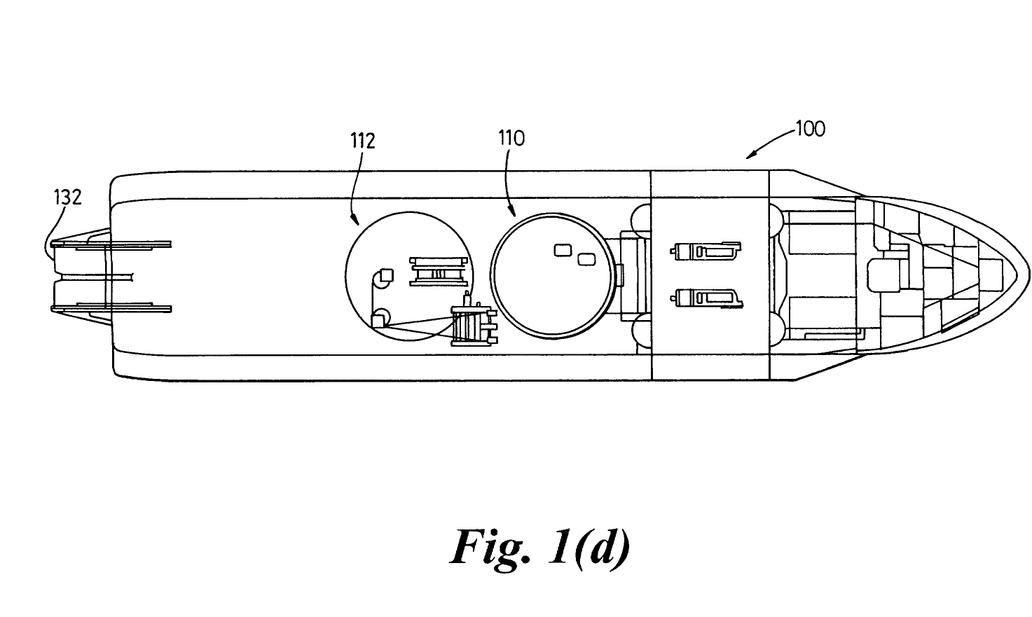

Referring to the general arrangement (GA) view shown in FIG. 1, a pipe laying vessel is shown in two different modes of operation in a partially cut-away side view in parts (a) and (b) of the drawing. Part (c) is a plan view corresponding to side view (b), in particular at a shelter deck level, being the highest deck on which most operations will be conducted. Part (d) shows additional features at and below a main deck level, below the shelter deck.

FIGS. 2, 3, 4 and 5 are enlarged views of the stern portion of the vessel, corresponding respectively to views (a), (b), (c) and (d) of FIG. 1. Accordingly, the following description applies to all of the FIGS. 1 to 5, in which the reader is invited to look at FIGS. 2-5 for more detail.

The vessel naturally comprises a hull 100 with a superstructure 102, located in this case forward of a larger working area. The vessel has various thrusters 104 to provide dynamic positioning (position holding) during pipe laying operations. The novel pipe handling apparatus to be described in detail below is configurable for the laying of rigid continuous pipe or alternatively flexible pipe. Such conduits and other elongate articles such as cables and umbilicals are known to the skilled reader. The reader will also appreciate that the arrangements required for laying these different types of articles generally mean that different equipment is used for the two purposes.

In the present example, a large reel 106 is provided for continuous rigid pipe and oriented with a horizontal axis. An extended spooling arm 108 is also provided. As an alternative or supplement to the reel 106, means may be provided on deck for welding pipeline from discrete sections, in a manner well known per se. For the storage and dispensing of flexible product, on the other hand, a carousel 110 located below deck level is provided. A second storage space 112 is provided, for cable and the like.

Various ancillary equipment in the form of winches, ROV garaging, and particularly cranes 120, 122, 124 and 126 is shown. The aft cranes 120, 124 are removed in most of the drawings, to allow a clear view of the apparatus 200. As will be appreciated by the skilled reader, these cranes play an important part in the pipe laying operations, particularly where end terminations or mid-line modules must be included, as well as in other hoisting operations of a more general nature. The outer cranes 120 and 124 are shown in alternative working positions, for illustration only. One such module 130 is shown in FIG. 2, for the sake of example, which would be suspended from crane 120 (not shown in FIG. 2).

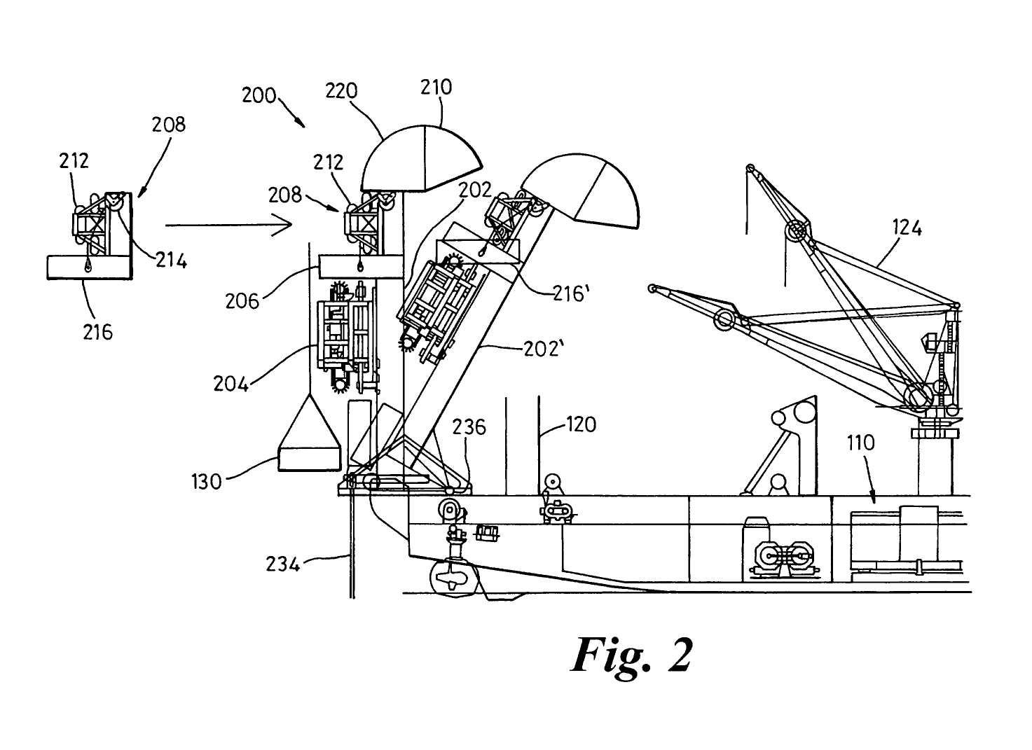

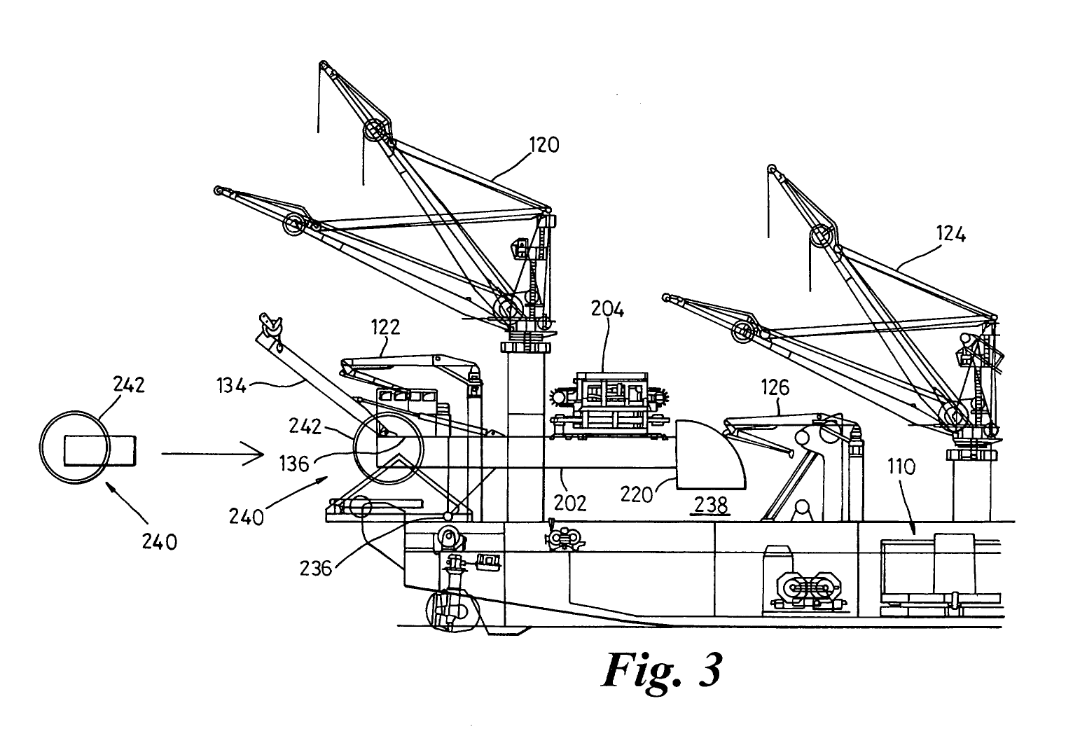

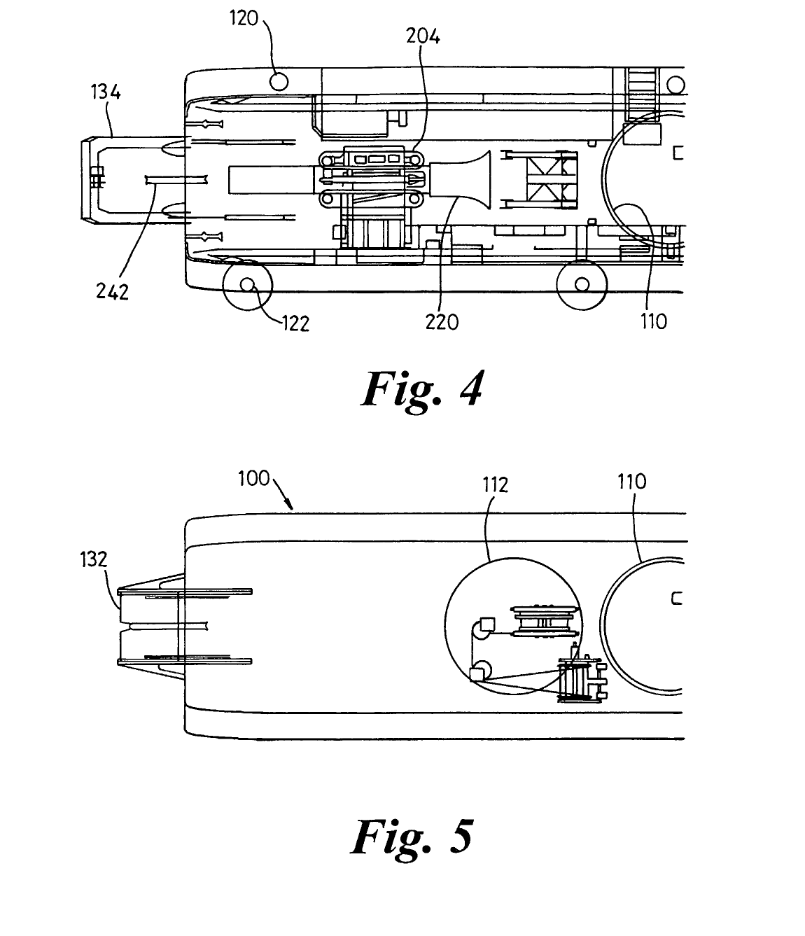

At the main deck level (FIG. 1(d) and FIG. 5 show this most clearly), a retractable working platform 132 is provided for handling such modules and connecting them to suspended pipe, for example. This platform is associated with a hang off clamp 133 in a known manner. Similarly, an A-frame 134 is mounted on a raised working deck 136 for further versatility in handling objects other than continuous pipe cable, this being best seen in FIGS. 3 and 4.

At the stern of the vessel is mounted the novel pipe handling apparatus 200, which is operable in different orientations, according to whether rigid or flexible pipe is being laid. Apparatus 200 comprises primarily a tiltable support structure 202 and a tensioning means in the form of a track-type tensioner 204 which can pay out pipe under considerable tension. The tensioner in this example comprises four rolling tracks arranged about the axis of the product being handled, which can be pressed together by hydraulic rams to squeeze the pipe, in a known manner. The tensioner 204 is shown always with its tracks open, in the accompanying drawings.

In FIGS. 1(a) and 2, the apparatus 200 is shown in an upright position adapted particularly for the laying of continuous rigid product. The structure 202 is shown both completely vertical and with the same structure in an off-vertical position shown with label 202′. In FIGS. 1(b), 1(c), 3 and 4, the apparatus 200 is shown in an alternative configuration, with the structure 202 and tensioner 204 lying horizontally for use in laying flexible product. Further differences between these configurations will be described in more detail below.

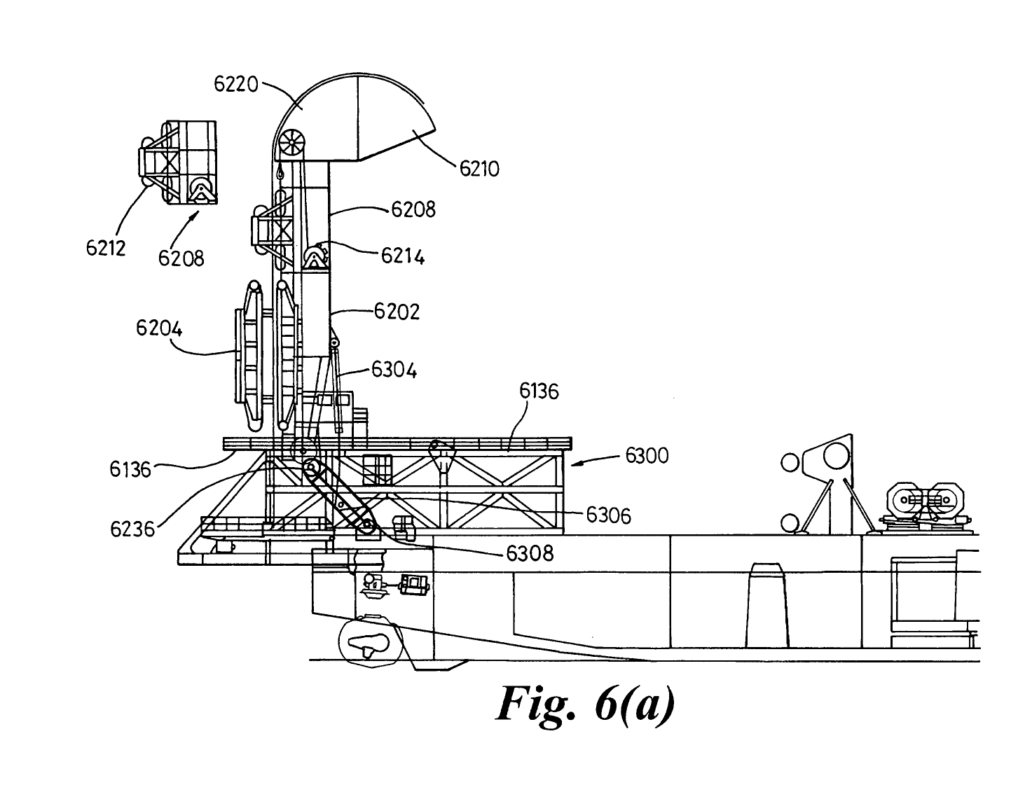

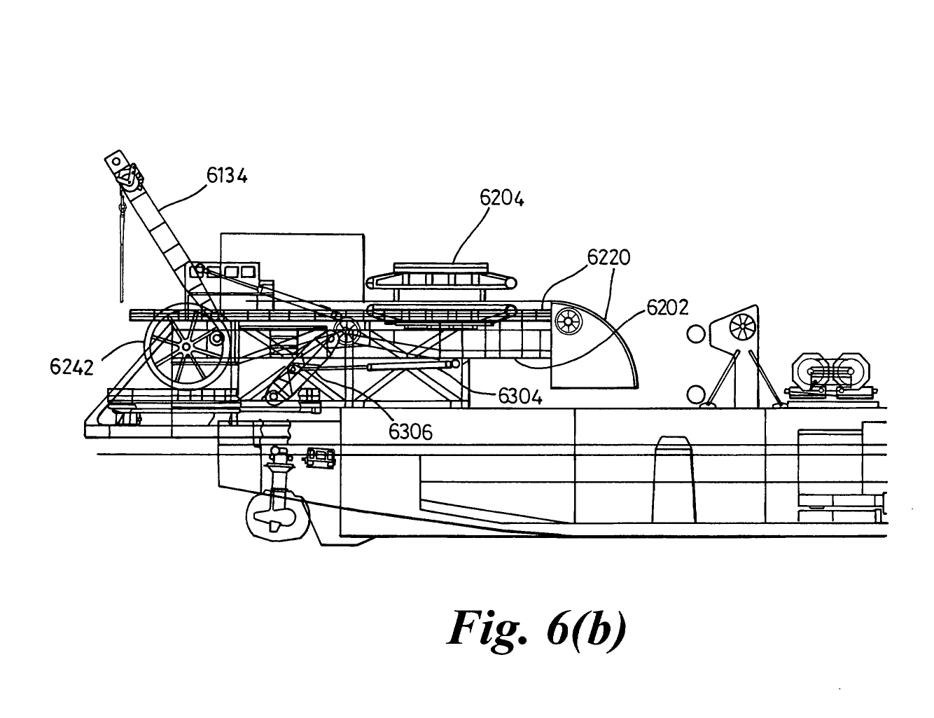

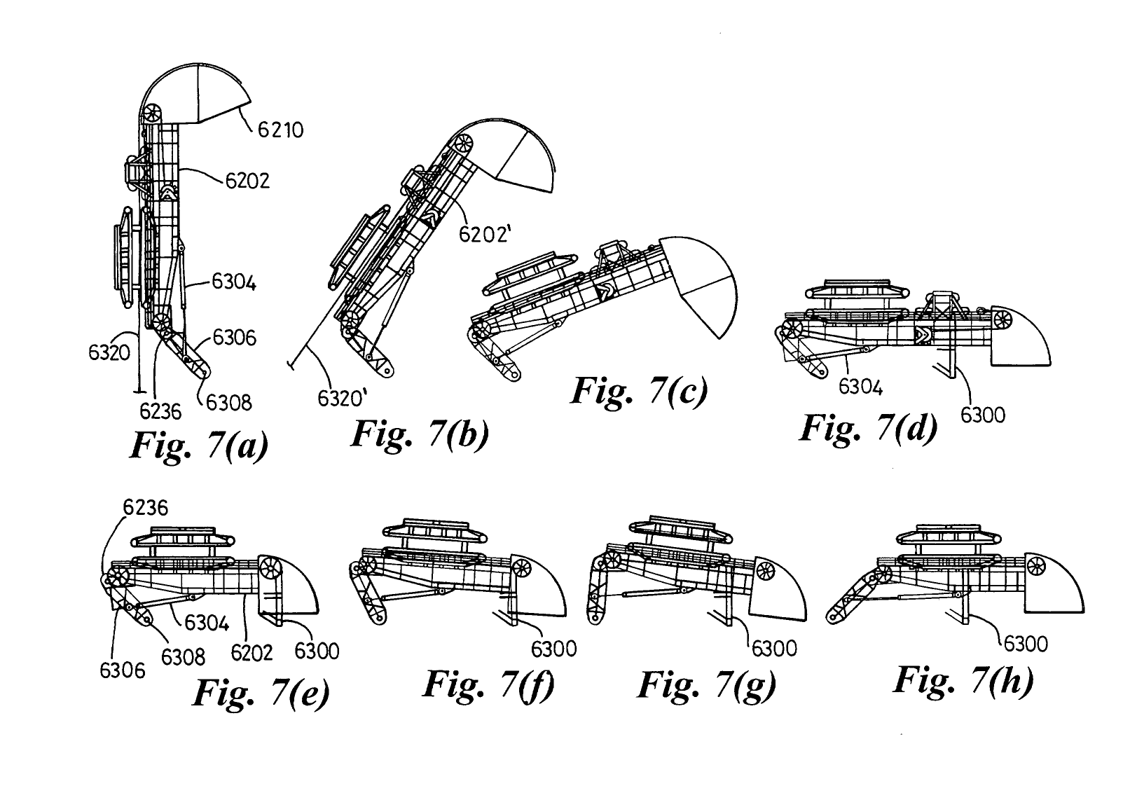

Also surrounding the tiltable structure 202 is an extension of working deck 136, supported on a fixed structure. This is not shown, for clarity, in FIGS. 1 to 5, but a similar fixed structure will be seen in detail in the example of FIGS. 6 and 7.

### Upright Configuration for Rigid Pipelay

Referring in particular to FIGS. 1(a) and the enlarged view in FIG. 2, it will be seen that additional modules are fitted to the structure 202 to enable it to perform the laying of rigid pipe in the vertical or near-vertical orientation. That is to say, in the present embodiment the equipment specific to rigid pipe laying is provided in modules 208 and 210 and 220 which can be detached to change from the upright mode of operation to the horizontal mode, described further below. Module 208 comprises a straightener 212 of well-known three-track type, a winch 214 and a tiltable working platform 216. Module 208 is also shown separated from the structure at the left hand side of FIG. 2. Module 208 also effectively extends the height of the tiltable structure 202. At the top or upstream end of structure 202 a radius controller 220 is fitted, and module 210 comprises an extension of this. As can be seen at 216′ in FIG. 2, the platform 216 can rotate to remain horizontal for workers thereon, as the structure 202 moves from its vertical position to an off-vertical position 202′.

In operation, continuous rigid product is unreeled from reel 106, via spooling arm 108 to the top of radius controller 220/210 where it is bent, potentially involving plastic deformation, to align with the lay axis and pass through the jaws of straightener 212. It will be noticed that spooling arm 108 reduces the span travelled by the continuous pipe laying between reel 106 and the apparatus 200, as indicated at 230 and 232 in FIG. 1(a). The straightener 212 removes the bending imparted by the reeling and radius controller 220, to supply a substantially straight product into the jaws of the tensioner 204. Tensioner 204 feeds the pipeline slowly down into the sea, while the reel 106 unwinds synchronously, with a certain back tension maintained for control and safety. The suspended weight of pipeline when operating at great depth can be very considerable (hundreds of tonnes), and the orientation of the structure 202, and hence tensioner 204, is controlled, together with positioning of the vessel, to ensure that the structure aligns very closely with the natural catenary path of the suspended pipeline. Accordingly, the part of the pipe which is under the heaviest tension is not subject to bending, and is less prone to damage.

It will be noted how the positioning of tensioner 204 on structure 202 allows the pipeline end termination (PLET) or other bulky module 130 to be accommodated in line between the outlet of the tensioner 204 and the retractable working platform 132. Hang off clamp 133 is used for suspending the pipeline (234 in FIG. 2) while this operation is conducted. Tensioner 204 can open to the position shown in the drawings, and winch 214 can be used to assist in manipulating module 130 into line, and for other abandonment and recovery operations.

Horizontal Configuration for Flexible Pipe laving

Referring now to FIGS. 1(b) and (c) and to FIGS. 3 and 4, structure 202 can now be seen in a fully horizontal position, which is convenient for flexible pipe to be laid. In reaching this configuration, tiltable structure 202 has moved about a pivot 236 under control of hydraulic rams or similar jacking means (not shown). The pivot 236 is level with the foot of the structure 202 when upright, but is offset from the line of the structure 202. By this arrangement, the structure 202 not only tilts from vertical to horizontal, but also moves bodily inboard, away from the line where the pipe, cable etc. is desired to enter the sea. This makes room for the overboarding sheave to be mounted to the downstream end of the structure 202.

In changing from vertical to horizontal configuration (which can be done at a shore base if necessary), the apparatus 200 has also been modified by the removal of modules 208 and 210, and the replacement of module 220 directly onto the end of structure 202, where module 208 was formerly located. Clearance 238 is indicated in FIG. 3, where the segment 210 has been removed and stowed elsewhere, on or off the vessel. It will be appreciated that the extended section 210 could be also a permanent part of radius controller 220, if a recess could be provided in the deck to accommodate it, or if space between the deck and structure 202 in its horizontal position were sufficient to accommodate it in any case. However, it is clearly more convenient for it to be removable.

While module 208 including the straightener 212 has been removed from the upstream end of the structure 202, a different module 240 has now been mounted at the downstream end, which comprises primarily an overboarding sheave 242, which is a wheel adapted to support and turn with a flexible pipe (not shown) as it passes from tensioner 204 over the stem of the vessel and into the sea. Using the radius controller 220 and other guiding means (not shown) it is therefore possible to unload a continuous flexible product from carousel 110, under control of tensioner 204, and pay it over the side without excessive bending or other damaging treatment.

### Design Considerations

Various considerations arise from the desire to use tensioners for handling both rigid and flexible pipelines and umbilicals. An important consideration for handling flexible pipes (and also coated rigid pipes) is to respect the maximum crush load of each product, whilst achieving the necessary friction to support the weight of suspended pipeline safely. Conventionally, tensioners adapted for handling rigid pipe are much shorter than flexible pipe tensioners, because they can squeeze harder without damaging the pipe and therefore require less contact length to achieve the necessary friction to hold the product. Compared with a normal rigid pipe tensioner, therefore, it will be seen that tensioner 204 in the apparatus 200 has a greater length than would be expected.

The squeeze pressure and pad design are also important parameters. The hydraulic control system of the tensioner unit in the novel apparatus will therefore be modified to provide a wider range of squeeze pressures. In particular, it proposed that a dual hydraulic system be used, whereby a number of the squeezing cylinders can be “turned off”. This will reduce the overall squeezing pressure without requiring fine adjustment of the hydraulic pressure, and effectively gives a dual range system.

With regard to pad design, a number of pad sets are provided to cover the range of different products. In a preferred embodiment, these are manufactured in two parts. A base piece is bolted to the tensioner track and stays in place for all operations, while an insert fitted with a quick release mechanism can be changed for a different insert relatively quickly. In particular, a number of sets of inserts with different radii and/or pad material will be used to cover the variety of products, while being light and easy to change.

Deck layout is also an important factor, in order to meet the requirements of both configurations. The tensioner position in each mode is generally pre-determined by the specification. Accordingly, in this example the tower rotation point 236 must be selected such that the tensioner always ends up in the desired place. Crane location is important to achieve adequate coverage for both types of operation and similarly winch location, lay routes and load-out methodology require consideration.

The apparatus and general arrangement of the vessel presented above and illustrated in the drawings satisfy these various considerations. In particular, in order to perform rigid lay in a vertical configuration and flexible lay in a horizontal configuration, there is provided a tower structure that can operate from 0° to 90° from horizontal. It is attractive to lay flexible products horizontally for operational reasons, including easier access, easier working and a general preference by particular customers. On the other hand, the vertical configuration can also be used for laying flexible products where necessary.

### Second Embodiment

FIG. 6 illustrates an alternative for the apparatus 200, with in particular a different pivoting and jacking mechanism from the apparatus of FIGS. 1-5. FIG. 6(a) shows the apparatus in the upright configuration, while FIG. 6(b) shows it in the horizontal mode. The same reference signs are used for the various components of the second apparatus, but with prefix ‘6’ to distinguish them from the corresponding parts of the apparatus of FIG. 1 to 5. Only the differences will be specifically described.

Firstly it will be seen in FIG. 6(a) that the extension of the raised working deck 6136 is visible, and supported below by a fixed structure 6300. Radius controller segments 6220 and 6210 are fitted on top of a removable module 6208, but in this example the winch 6214 is located lower in the module 6208, and it co-operates with a sheave 6302 mounted in the radius controller section 6220. The functions of these elements is the same as in FIG. 1, however.

The structure is again moved from upright to horizontal by pivoting about a pivot 6236, and in this example the hydraulic ram 6304 responsible for this movement is shown (in practice two or more rams will be provided and operate in parallel). In this second example, however, the pivot point 6236 is not fixed with respect to the deck, but is moveable. Specifically, pivot 6236 is at the end of an arm 6306, which in turn is connected to the deck at a pivot 6308. Ram 6304 acts not between the structure 202 and the deck, but between the structure 202 and an intermediate point on arm 6306. As will be illustrated with reference to FIG. 7(a) to (h), this allows the same ram 6306 to perform the two actions of pivoting the structure down to horizontal and retracting it inboard to make room for the overboarding sheave 6242, while also separating those actions. This provides more design freedom than the single pivot 236 in the first example. The articulated structure 6202/6306 can be moved using significantly less powerful rams than would be required to move the structure 202 as a unit. Depending on the exact layout, it may also allow the heavy tensioner 6204 and the working deck 6136 to be mounted lower, aiding stability of the vessel overall.

In FIG. 7, steps in the movement of the structure 6202 and associated parts are shown, with all surrounding structure removed for clarity. Steps (a) to (d) describe the lowering of the structure from vertical to horizontal, while steps (e) to (h) show the subsequent process of retraction. Step (a) corresponds to the state of the apparatus shown in FIG. 6(a), while step (h) corresponds to the state shown in FIG. 6(b).

In all of steps (a) to (d), it should be appreciated that the arm 6306 is pinned somewhere along its length to a part of the fixed structure 6300, so that it maintains a fixed orientation. Pivot 6308 is fixed to the deck, so in this phase of operation pivot 6236 is also fixed with respect to the vessel. In step (a), the structure 6202 is vertical, and indeed is in use for the laying of continuous rigid pipe 6320 under control of the tensioner 6204 (shown open here but in practice clamped shut to grip the pipeline 6320). Step (b) shows the structure still in use for laying pipe, but inclined to achieve a lay angle of 35 degrees or so off-vertical. To reach this position ram 6304 has contracted a little.

In steps (c) and (d), ram 6304 contracts still further by stages, until the tiltable structure 6202 is fully horizontal and within the fixed structure 6300 which supports the working deck 6136 (not shown). Part of the fixed structure 6300 is shown in FIGS. 7(d) to (h), to provide a point of reference for the reader to follow the subsequent movement of the structure 6202 as it retracts inboard from the stem of the vessel.

For steps (e) to (h), the pin connecting arm 6306 to the fixed structure 6300 is now removed, so that the arm is free to pivot now about the second pivot 6308, fixed on deck. This changes the action when the ram 6304 subsequently expands again. Following the sequence of steps (e) to (h) in the drawing, and watching the position of structure 6202 relative to the portion of fixed structure 6300 which is show for comparison, it will be seen how expansion of ram 6304 now causes the structure 6202 to cant slightly, but also to be displaced horizontally away from the stem of the vessel. At the end of the movement, with ram 6304 fully extended, the structure 6202 is again fully horizontal.

### Third Embodiment

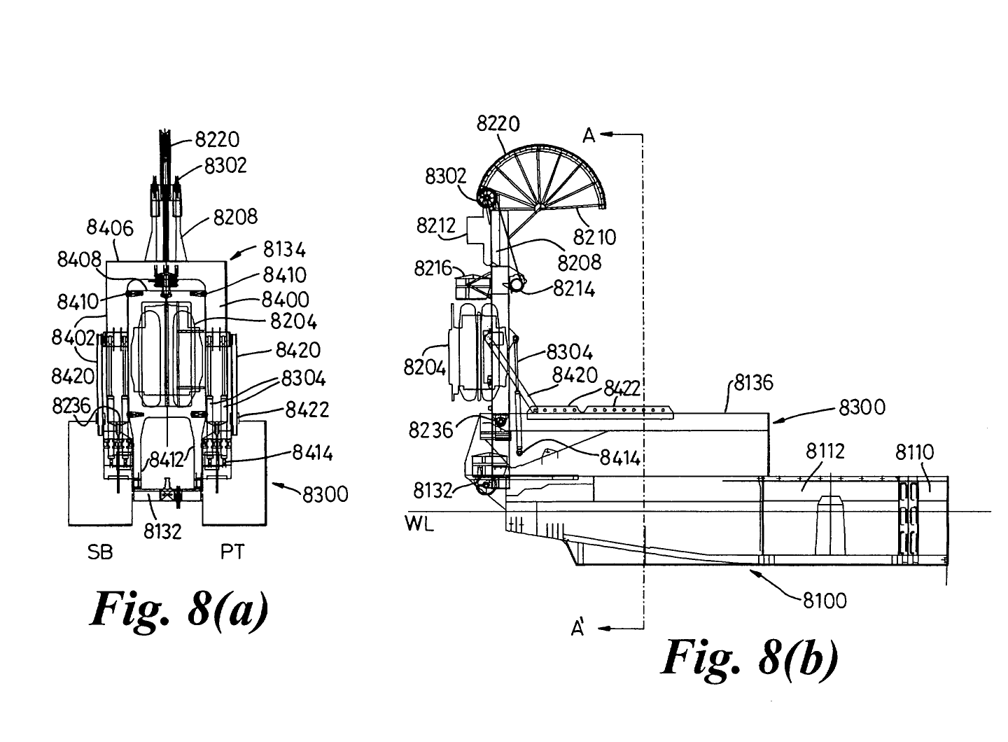

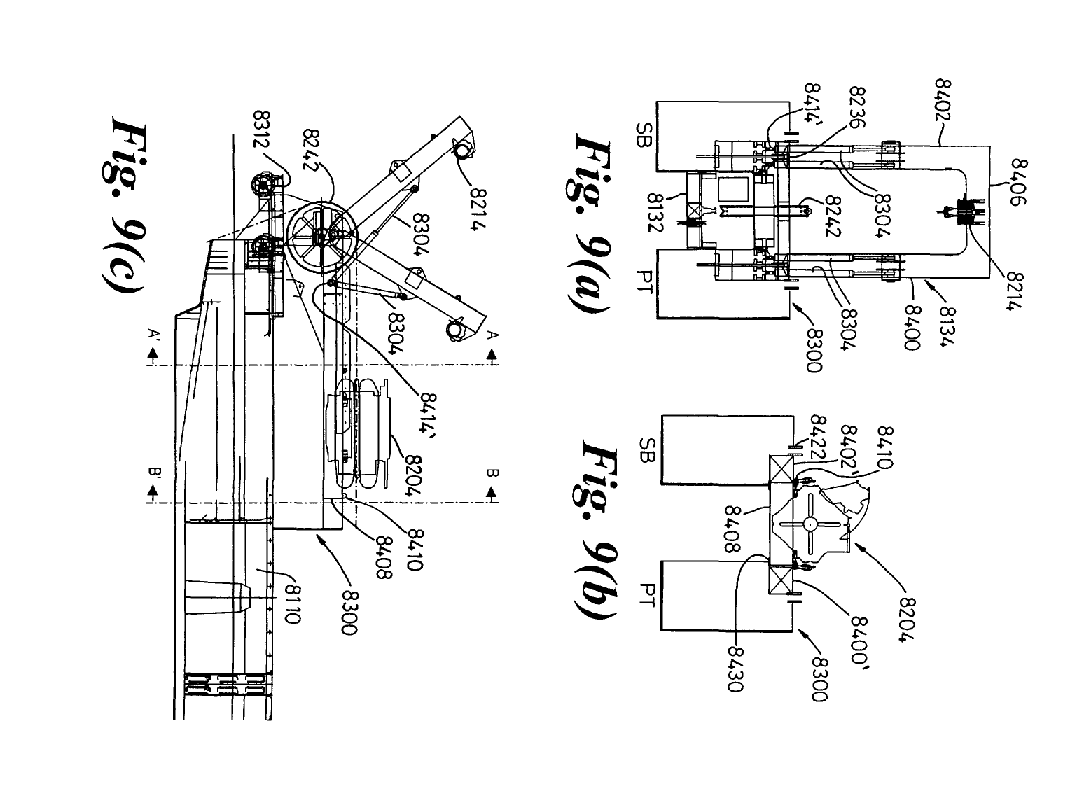

FIGS. 8 and 9 illustrate a further alternative for the apparatus 200. This also includes a different pivoting and jacking mechanism from the apparatus of FIGS. 1-5. Most significantly, the functions of the separate tower 202 and A-frame 134 of the first two embodiments are combined in a single A-frame structure 8134. For horizontal operation, the tensioner detaches from the A-frame/tower, so that it may again elevate to be used for handling bulky accessories.

FIGS. 8(a) and (b) show the apparatus in the upright configuration, while FIGS. 9(a), (b) and (c) show it in the horizontal mode. The same reference signs are used for the various components of the first apparatus, but with prefix ‘8’ to distinguish them from the corresponding parts of the apparatus of FIGS. 1 to 7. Only the differences will be specifically described.

Referring firstly to FIGS. 8(a) and (b), it will be seen that the combined tower and A-frame 8134 is substantially stronger than A-frame 134 of the first example, comprising box sections to form port (PT) and starboard (SB) legs 8400, 8402 and crossbeam 8406. Again there is provided a raised working deck 8136 supported on a fixed structure 8300 not shown in detail. The A-frame 8134 is again moved from upright to horizontal by pivoting about a pair of pivots 8236, and in this example the pivot points are fixed on the structure 8300 and do not move between modes. At each side (port PT and starboard SB) a pair of hydraulic rams 8304 are arranged to control this movement, extending between the respective leg 8400/8402 and a bearing point 8414 on the fixed structure 8300. In parallel, at each side a strut 8420 is provided to brace the structure at a range of angles (from vertical to over 60° forward) using removable pins and arrays of pinning points 8422 at both port and starboard sides. This provides additional safety against failure of the hydraulic system powering rams 8304. The strut and rams acting on each leg 8400/8402 are strong enough to hold the A-frame 8134 and its loads at the desired angle independently of those on the other leg.

Tensioner 8204 (shown in outline) is permanently mounted on a tensioner frame 8408. In the vertical mode for rigid Pipelaying, frame 8408 is held between the legs of the A-frame by a locking mechanism 8410 comprising, for example, four retractable locking pins and corresponding sockets. In this example, extensions 8412 of the tensioner frame are also provided which end in pivot points for suspending the lower working table 8132 and hang off clamp on the product axis at a suitable distance below the tensioner 8204. ( The mounting of the working table on these extensions allows for a greater off-vertical orientation of the apparatus. In an alternative embodiment where such extreme inclination is not required, the lower working table 8132 is supported on the vessel or the structure 8300, and slides in and out to maintain its position on the product axis. In that case the extensions 8412 of the tensioner frame 8408 can be dispensed with.)

Radius controller segments 8220 and 8210 are fitted on top of a removable module 8208, which again carries straightener 8212 and tiltable working platform 8216 (not shown in FIG. 8 (a) for clarity). In this example a double-drum winch 8214 is located permanently on the forward side of A-frame 8134 rather that on module 8208. This co-operates with sheaves 8302 mounted in the radius controller section 8220 to provide the same functions as in FIGS. 1-7. The winch also provides a hoist function in the second mode, however.

In operation, rigid product (typically steel pipe) is hauled over the radius controller 8210/8220 and through straightener 8212, passing through tensioner 8204 and into the sea. The A-frame 8134, and hence the tensioner 8204, are kept aligned with the desired product axis, according to the depth of water, tension in the product and so forth. This is done primarily using the rams 8304, assisted also by the struts 8420. The supply of product can be from a reel as in FIG. 1, or from welding on board as shown in U.S. Pat. No. 5,975,802, mentioned above. These operations will be well-known to those skilled in the art and not described further in detail.

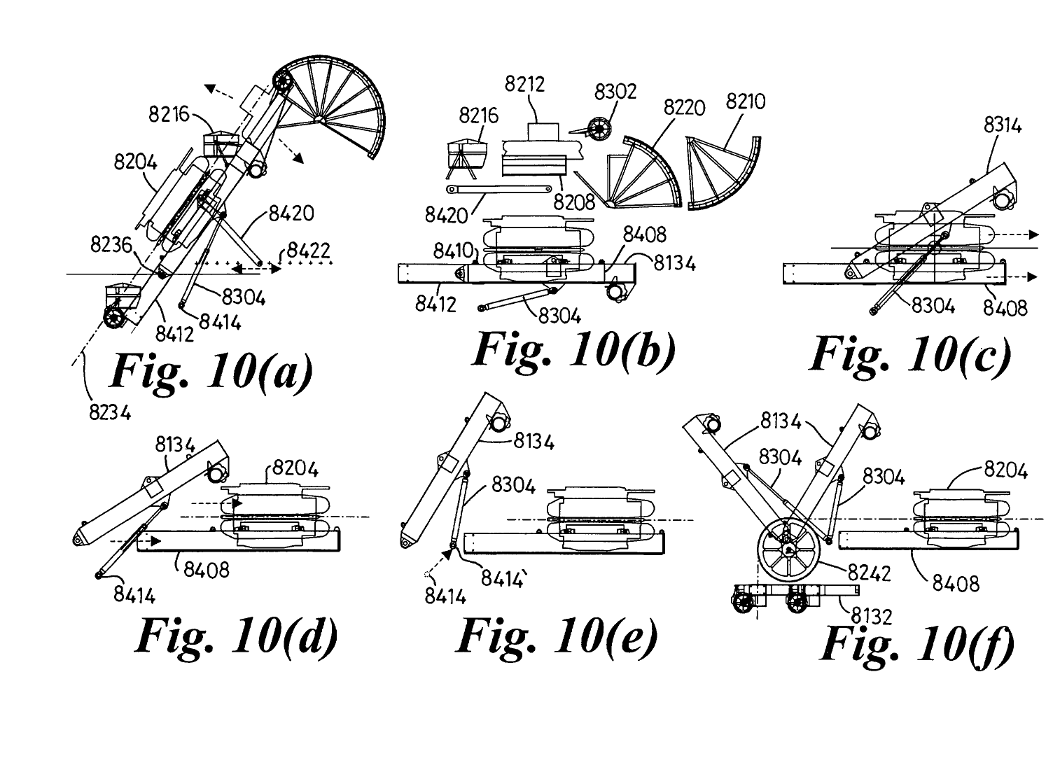

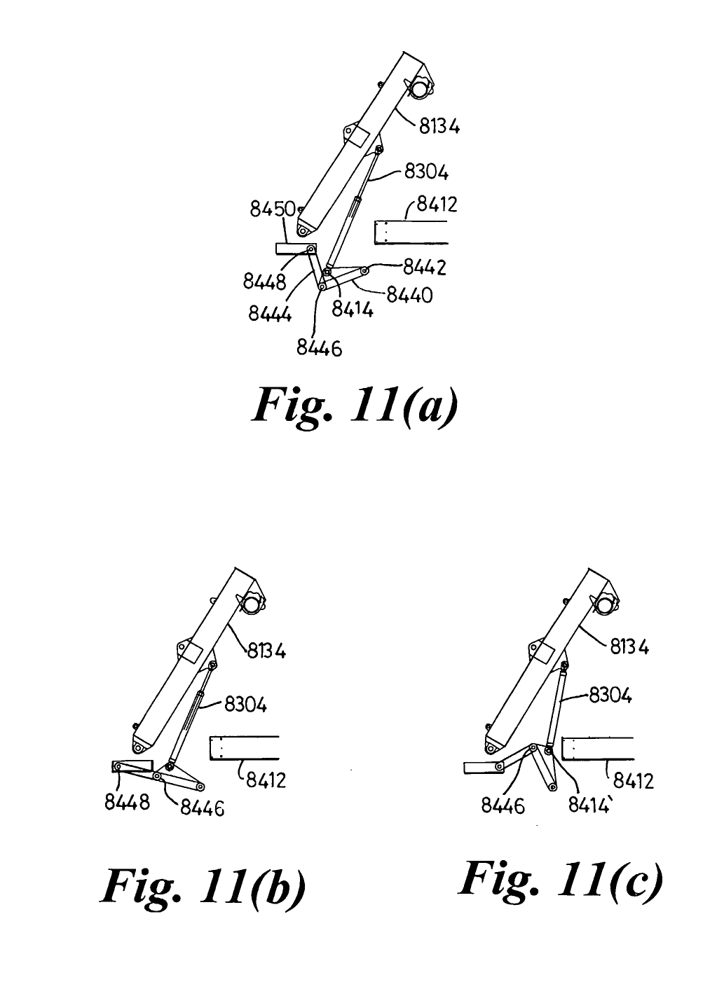

FIGS. 9(a) to (c) show the same apparatus converted to a second mode for laying flexible product from the storage tanks 8110 and 8112. The sequence of conversion will be described in detail with reference to FIGS. 10 and 11. In FIG. 9 it can be seen that the components 8208, 8210, 8212 and 8220 have been removed from the top beam 8406 of the A-frame 8134. An overboarding sheave 8242 has been added generally at the base of the A-frame to receive flexible pipe from tensioner 8204 and support it as it is diverted to a more vertical path for launching to the seabed.

The tensioner 8204 has been left horizontal and fixed to the structure 8300 through its frame 8408 and locking mechanism 8410. In FIG. 9(b), boxes 8400′ and 8402′ indicate spacers to maintain a usable and safe working deck, where the structure provides space for the legs 8400 and 8402 of A-frame 8134 to lie down to deposit and pick-up the frame 8408 carrying the tensioner 8204. Compared to the first two examples, it can be seen how there is no longer a need for a massive tower structure (202 in FIGS. 1 to 5) to lie down passively merely because the tensioner is being operated in the horizontal mode. Skidways 8430 are provided for the frame and tensioner to be shifted several metres fore and aft in the process of conversion between modes, as will shortly be described and illustrated in more detail with reference to FIG. 10. This allows space between tensioner 8204 and sheave 8242 for working on the pipe and for deflecting it to pass in-line accessories over it without clashing with the tensioner. As shown partially in FIG. 9(b) and the other figures, tensioner 8204 opens to allow passage of such items when the need arises.

Also compared with the first configuration of the apparatus as shown in FIG. 8, it will be seen that the bearing points 8414 for the rams 8304 have been moved upward to new positions 8414′. This is to facilitate the complete range of outboard movement illustrated in FIG. 9(c). This is at the expense of a reduced range of inboard movement compared with the first mode, but allows a more compact footprint and use of shorter rams 8304. The struts 8420 are also not used in this configuration, as the A-frame is not carrying the tension of the suspended pipeline, and is required to move smoothly inboard and outboard over the suspended pipe, in order to pass bulky accessories, joints etc overboard without bearing on the sheave 8242. The winch 8214 serves to hoist these loads.

FIG. 10 shows steps (a) to (f) in the conversion from the rigid lay or vertical mode to the flexible pipe lay or horizontal mode. These steps can be simply reversed to perform the reverse conversion. Only the key moving parts as seen from the starboard side are shown to allow clarity. The same reference signs are used for these components as in FIGS. 8 and 9 and they will not be reiterated here.

In Step (a) the apparatus is in the same “vertical” mode as in FIG. 8, although the tower is shown inclined at an angle some way of vertical, to suit for example pipe 8234 being laid in shallower water. In this first mode the frame 8134 can be inclined to steeper or shallower angles as illustrated by dashed arrows. The rams 8304 provide the motive force for this, while the struts 8420 can be unlocked and locked at different positions on the array 8422 of locking points. In operation the suspended weight of the pip being laid is carried by tensioner 8204, and hence through the A-frame and struts.

In Step (b), a rectangular portion of working deck 8136 forward of A-frame pivots 8236 has been removed for conversion to the second mode, and A-frame 8134 has been lain down completely. Components 8210 etc. have been detached from it ready for stowage on- or off-board the vessel. The locking mechanism 8410 of the tensioner frame 8408 is disengaged from the A-frame legs 8400/8402, to break the link between the tensioner frame 8408 and A-frame 8134. It goes without saying that the locking mechanism must be sufficiently strong in each mode to support the entire tension in the pipeline, as well as the weight of the tensioner and frame in the vertical mode. The weight of the tensioner and tensioner frame 8408 is then taken on the skidways 8430 (seen in FIG. 9(b)).

In Step (c) the A-frame 8134 is lifted using the rams 8304 sufficiently high that the tensioner 8204 on its frame 8408 can be skidded several metres forward along the skidways 8430. This can be done using a winch (not shown), although obviously rack-and-pinion, hydraulic rams or other drive means would also be suitable.

In Step (d) the frame and tensioner have reached the appropriate position for the horizontal mode of operation and the locking mechanism 8410 are engaged into suitable sockets in the fixed structure 8300. At some point the spacers 8400′ and 8402′ (seen in FIG. 9(b)) are inserted alongside the tensioner frame and a smaller portion of working deck restored between the tensioner frame and pivots 8236 of A-frame 8134.

In Step (e) the bearing points of the rams 8304 are moved from their position 8414 to their higher position 8414′. Remembering that only the starboard side components are shown in FIG. 9(e), it is explained that the starboard side rams 8304 can be disconnected at 8414 and reconnected at 8414′ while the port side rams support A-frame 8134. Once the starboard side rams are secure in their new bearing point, the port side rams can be disconnected and reconnected at their higher bearing position. Tracks or the like can be provided to guide the ram ends between these two positions. (FIG. 11, described below, shows a more elaborate system of links whereby the bearing position of rams 8304 can be moved from 8414 to 8414′ without disconnection.)

Step (f) shows the finished horizontal mode configuration in which the overboarding sheave 8242 has been fitted to the rear of structure 8300 and A-frame 8134 can swing fully inboard and outboard over it, for laying of flexible pipes, cables etc., under control of tensioner 8204 in its horizontal orientation. Also shown in FIG. 10(f) is the sliding version of working table 8132, in both extended and retracted positions.

FIG. 11 shows a system of links whereby the bearing position of rams 8304 can be moved from 8414 to 8414′ without disconnection, in going from vertical to horizontal mode and vice versa.

The bearing point 8414/8414′ in this modification is provided not by fixed points on the supporting structure 8300, but by a bearing point on a first link 8440 pivotally connected at its forward end to a fixed point 8442 on the structure 8300. The first link 8440 at its stem end is to one end of a second link 8444 at floating pivot point 8446. The opposite end of link 8444 is pivotally mounted on a slider 8448 which is constrained to slide fore and aft in a short track 8450. In the first mode of operation, slider 8448 is locked at the forward end of the track and thus the entire linkage 8440-8444 are locked in the V-shaped configuration shown in FIG. 11(a). This provides a fixed bearing point 8414 for the rams 8304 to support and control the attitude of A-frame 8134.

In order to transfer this bearing point to the upper position 8414′ for the second mode of operation, the lock on the slider 8448 is first released, and then the ram 8304 is retracted. With the slider free to move aftward in its track 8450, linkage 8440-8444 is free to be drawn upwards by ram 8304, as shown in an intermediate position in FIG. 11(b). It is recalled that only the starboard side components are shown, the A-frame 8134 being supported throughout this operation by the rams 8304 of the opposite side, or alternatively by a strut 8420.

The linkage is designed such that, once the ram 8304 is fully retracted (or nearly so), the links 8440, 8444 are in the inverted-V configuration shown in FIG. 11(c), and slider 8448 has returned to the forward end of track 8450. At the same time, the bearing point on link 8440 at the foot of ram 8304 is in the desired upper bearing position 8414′. Locking slider 8448 again at the forward end of the track fixes the bearing point 8414′ in its new position and the starboard ram 8304 can once again take the weight of A-frame 8134. The same steps can then be repeated at the port side, until the rams 8304 are fixed at 8414′ on both port and starboard sides, and the A-frame can be swung inboard and outboard as shown in FIG. 9(c). To revert to the first mode, the process is simply reversed.

### Conclusion

The above three examples show a range of different implementations of a “dual-mode” pipe laying apparatus, and further variations within those implementations have also been described. Further modifications can be considered, for example:
Features from the different examples can be combined with each other in various ways according to the needs of a given project.
Other types of tensioning means may be substituted for the track tensioners shown.
Other types of drive besides hydraulic rams can be used in the tensioner and other parts of the apparatus.
Radius controllers may be smooth chutes as shown, and/or may comprise sheaves or tracked arches.
Tracks and sheaves may be powered or passive.
Instead of being located at the stem of a vessel, the apparatus may be adapted to launch the product over the side or the bow, or through a “moonpool”.

The apparatus can also be configured for handling flexible pipe with the tower and tensioner in the vertical orientation, offering yet further versatility in the range of depths and types of pipe handled. In particular, pipe or other product may be damaged by being bent over the overboarding sheave at a high tension, corresponding for example to a greater than usual depth of water. If the tensioner is aligned with the catenary curve of suspended flexible pipe by using the apparatus in its vertical orientation, the risk of such damage is reduced.

Of course various further modifications of the above examples can be envisaged by the skilled person, without departing from the spirit or scope of the invention in one or more of its aspects.

1. Apparatus for laying elongate articles from a vessel at sea, the apparatus comprising tensioning means for controlling paying out of said articles along an axis of said tensioning means, a structure tiltable between upright and horizontal states, wherein the apparatus is operable in a first mode wherein the tensioning means is carried by said structure with its axis at an elevated angle, aligned with a departure angle of the article being laid, and in a second mode wherein the tensioning means is arranged with its axis substantially horizontal, the apparatus in the second mode comprising overboarding means for receiving flexible elongate product from the tensioning means along said axis and diverting it to a more vertical angle for departure from the vessel.

2. Apparatus claimed in claim 1 wherein the tiltable structure in the first mode carries a radius controller and a straightener for conditioning rigid pipe at a position upstream of the tensioning means.

3. Apparatus as claimed in claim 2 wherein the radius controller and/or the straightener are provided at least partially in the form of modules which can be removed when the apparatus is operated in the second mode.

4. Apparatus as claimed in claim 3 wherein the overboarding means comprises a sheave.

5. Apparatus as claimed in claim 1 wherein the overboarding means is provided at least partially in the form of a module which can be removed when the apparatus is in the first mode.

6. Apparatus as claimed in claims 1 wherein the tiltable structure is operable in the first mode to orient the tensioning means vertically and at a range of angles below vertical.

7. Apparatus as claimed in claim 1 wherein in said second mode the tensioning means is detached from and supported independently of the tiltable structure, the tiltable structure being returned to an upright orientation for supporting loads independently of the tensioning means.

8. Apparatus as claimed in claim 7 wherein the tiltable structure can be operated in the second mode at a range of angles either side of vertical, to support in-line accessories as the product travels over said overboarding means.

9. Apparatus as claimed in claim 1 wherein the tensioning means in the second mode is located at a position displaced horizontally from a location from which it will be elevated by said tiltable structure in the first mode.

10. Apparatus as claimed in claim 1 wherein the tiltable structure comprises a pair of legs pivoted to the deck of the vessel at their lower ends and joined by a crossbeam at their upper ends, the tensioning means in the first mode being carried between the legs below the crossbeam, with a straightener and radius controller mounted above the crossbeam and being detachable when adapting the apparatus into the second mode.

11. Apparatus as claimed in claim 9 wherein the tiltable structure is movable to provide said horizontal displacement of the tensioning means.

12. Apparatus as claimed in claim 11 wherein the tiltable structure is connected to the vessel by one or more arms pivotally connected at one end to the tiltable structure and at another end to the vessel.

13. Apparatus as claimed in claim 1 wherein the hydraulic control system of the tensioning means is a dual hydraulic system.

14. Apparatus as claimed in claim 1 wherein the tensioning means include pads for gripping the elongate article, each pad comprising a base piece bolted to the tensioning means and an insert fitted with a quick release mechanism so that it can be changed for a different insert.

15. A method of configuring apparatus for laying elongate articles from a vessel at sea, the apparatus comprising tensioning means for controlling paying out of said articles along an axis of said tensioning means, a structure tiltable between upright and horizontal states, wherein the apparatus is configurable in a first mode wherein the tensioning means is carried by said structure with its axis at an elevated angle aligned with a departure angle of the article being laid, and in a second mode wherein the tensioning means is arranged with its axis substantially horizontal, the apparatus in the second mode comprising overboarding means for receiving flexible elongate product from the tensioning means along said axis and diverting it to a more vertical angle for departure from the vessel, the method including detaching certain operating equipment from the structure, moving the structure between the upright position and the horizontal position and locating certain operating equipment for operation with the structure in the particular mode of operation.

16. A method as claimed in claim 15 wherein the operating equipment is provided as modules which can be removed and relocated with respect to the structure.

17. A method as claimed in claim 15 wherein in the first mode a radius controller and/or straightener are provided at least partially in the form of modules which can be removed when the structure is in the horizontal state.

18. A method as claimed in claim 17 wherein the tensioning means in the second mode is located at a position displaced horizontally from a location from which it will be elevated by said tiltable structure in the first mode.

19. A method as claimed in claim 18 wherein said operating equipment includes the overboarding means itself, which is detached from said tiltable structure in said first mode.

20. A method as claimed in claim 19 wherein said operating equipment includes the tensioning means itself, which is detached from and supported independently of said tiltable structure in said second mode.

21. A method of laying rigid pipeline from a vessel, the method comprising paying out the pipeline using an apparatus as claimed in any claim 1, operated in its first mode, the tensioning means gripping and paying out the rigid pipeline while supported on said tiltable structure at an angle aligned with the angle of departure of the pipeline from the vessel.

22. A method of laying flexible pipeline from a vessel, the method comprising paying out the pipeline using an apparatus as claimed in 1, operated in its second mode, the tensioning means gripping and paying out the flexible pipeline along said substantially horizontal axis, the pipeline being diverted by said overboarding means from said horizontal axis to the angle of departure of the pipeline from the vessel.
